(19) United States
(12) Patent Application Publication
(10) Pub. No.: US 2018/0373426 A1
(43) Pub. Date: Dec. 27, 2018

(54) Information Showing Method and Apparatus, and Electronic Device

(71) Applicant: Beijing Kingsoft Internet Security Software Co., Ltd., Beijing (CN)

(72) Inventors: Shiduo YANG, Beijing (CN); Yian LIN, Beijing (CN); Yinmeng YANG, Beijing (CN)

(21) Appl. No.: 15/777,763

(22) PCT Filed: Nov. 18, 2016
(86) PCT No.: PCT/CN2016/106396

§ 371 Date: May 21, 2018

(30) Foreign Application Priority Data
Nov. 20, 2015 (CN) 201510809954.1

(51) Int. Cl. G06F 3/0488; G06F 3/0481

(52) U.S. Cl. CPC G06F 3/04886; G06F 3/0481

(57) ABSTRACT

The embodiments of the present application disclose an information display method, apparatus, and electronic device, which involves the field of computer software technology. The method comprises: receiving an information display instruction for a locked screen interface; obtaining to-be-displayed information according to a preset information determining rule; displaying the obtained to-be-displayed information and a screen unlocking area with a preset style according to a preset interface layout mode. With the solutions provided in the embodiments of the present application to display information, the way the user obtains information is enriched and user experience is improved.

The present application claims the priority to a Chinese patent application No. 201510809954.1 filed with the State Intellectual Property Office of the People's Republic of China Nov. 20, 2015 and entitled “Information Showing Method and Apparatus, and Electronic Device”, which is incorporated herein by reference in its entirety.

### TECHNICAL FIELD

The present application relates to the field of computer software technologies, and in particular, to an information display method, apparatus, and electronic device.

### BACKGROUND

With the rapid development of hardware technology, the capability of terminals used by users has become better and better. For example, a user can take photos, chat with friends, visit web pages, and the like with his terminals. As the capability of terminals used by users are becoming increasingly better, more and more information concerning user privacy is stored in the terminals. In view of this, a user often set a locked screen interface for his terminal or an application installed in the terminal. When the user wants to obtain information from the terminal he uses, he has to unlock the terminal or unlock an application installed in the terminal by inputting the correct password. It can be seen that, in the prior art, after a locked screen interface is set for the terminal used by the user or an application installed in the terminal, the user may obtain information in only one way, thus resulting in bad user experience.

### SUMMARY

Embodiments of the present application disclose an information display method, apparatus, and electronic device to enrich the way of obtaining information by a user and improve user experience.

To achieve the objective above, an embodiment of the present application discloses an information display method. The method includes:

receiving an information display instruction for a locked screen interface;

obtaining to-be-displayed information according to a preset information determining rule; and

displaying the obtained to-be-displayed information and a screen unlocking area with a preset style according to a preset interface layout mode.

In a specific implementation of the present application, the information display method further includes:

receiving a detail display instruction for first target information, wherein the first target information is the information being displayed in the obtained to-be-displayed information; and

invoking an application corresponding to the first target information to display details of the first target information.

In a specific implementation of the present application, invoking an application corresponding to the first target information to display details of the first target information comprises:

determining whether the application corresponding to the first target information belongs to a preset unlock invoking list, wherein the preset unlock invoking list is used to record applications that can only be invoked after unlocking a screen;

if so, invoking the application corresponding to the first target information and displaying the details of the first target information in the invoked application, when the screen has been successfully unlocked; and

if not, invoking directly the application corresponding to the first target information and displaying the details of the first target information in the invoked application.

In a specific implementation of the present application, the information display method further includes:

receiving an instruction for setting information filtering conditions;

presenting an interface for setting information filtering conditions; and

generating an information filtering condition, according to operations by the user on the interface for setting information filtering conditions.

In a specific implementation of the present application, displaying the obtained to-be-displayed information and a screen unlocking area with a preset style according to a preset interface layout mode comprises:

determining whether pieces of information in the obtained to-be-displayed information conform to the information filtering condition one by one; and

displaying, according to a determination result, a piece of information in the obtained to-be-displayed information which does not conforms to the information filtering condition and the screen unlocking area with the preset style in accordance with the preset interface layout mode.

In a specific implementation of the present application, displaying the obtained to-be-displayed information and a screen unlocking area with a preset style according to a preset interface layout mode comprises:

obtaining a sequence number of a second target information in the obtained to-be-displayed information and the number of pieces of information in the obtained to-be-displayed information, wherein the second target information is the information in the obtained to-be-displayed information which will be displayed;

determining whether to display prompt information for information switching according to the sequence number of the second target information and the number of pieces of information in the obtained to-be-displayed information; and

if it is determined to display the prompt information for information switching, displaying the prompt information for information switching, the second target information, and the screen unlocking area with the preset style, in accordance with the preset interface layout mode and a preset prompt information style.

In a specific implementation of the present application, the preset prompt information style is set so that:

the content in a second preset area of third target information is displayed in a first preset area in the locked screen interface, wherein the third target information is to-be-displayed information corresponding to a next sequence number to the sequence number of the second target information; or

the content in a fourth preset area of fourth target information is displayed in a third preset area in the locked screen interface, wherein the fourth target information is to-be-displayed information corresponding to a sequence number preceding the sequence number of the second target information; or

the prompt information for information switching is displayed with a preset graphics in a fifth preset area in the locked screen interface.

In a specific implementation of the present application, the information display method further includes:

receiving an information switching instruction, after displaying the prompt information for information switching, the second target information, and the screen unlocking area with the preset style, in accordance with the preset interface layout mode and a preset prompt information style; and

displaying the switched to-be-displayed information according to the information switching instruction.

In a specific implementation of the present application, displaying the switched to-be-displayed information according to the information switching instruction comprises:

determining whether the to-be-displayed information being displayed contains preset information;

if the preset information is contained in the to-be-displayed information being displayed, determining whether the preset information conforms to a preset information shift condition according to the switched to-be-displayed information corresponding to the information switching instruction; and

if the preset information conforms to the preset information shift condition, displaying the switched to-be-displayed information, and displaying the preset information at a preset position.

In a specific implementation of the present application, obtaining to-be-displayed information according to a preset information determining rule comprises:

obtaining the to-be-displayed information according to at least one of the following:

an application locked by the locked screen interface;

an application running in the foreground on the terminal before the screen is locked;

an application running in the terminal before the screen is locked;

categories of applications installed in the terminal;

frequency of use of the applications installed in the terminal;

user's interests and hobbies obtained by analyzing information on running of applications installed in the terminal;

categories of to-be-displayed information, which are set in advance by the user; and

information recommendation degree of each piece of information in a preset information repository.

In a specific implementation of the present application, the screen unlocking area with the preset style comprises:

a digital type of screen unlocking area arranged according to a preset graphics; or

an image type of screen unlocking area arranged according to a preset graphics; or

a screen unlocking area for collecting images; or

a screen unlocking area for collecting sounds.

To achieve the objective above, an embodiment of the present application discloses an information display apparatus. The apparatus includes:

an information displaying instruction receiving module, configured for receiving an information display instruction for a locked screen interface;

an information-to-be-displayed obtaining module, configured for obtaining to-be-displayed information according to a preset information determining rule; and

an interface information displaying module, configured for displaying the obtained to-be-displayed information and a screen unlocking area with a preset style according to a preset interface layout mode.

In a specific implementation of the present application, the information display apparatus further includes:

a detail displaying instruction receiving module, configured for receiving a detail display instruction for first target information, wherein the first target information is the information being displayed in the obtained to-be-displayed information; and

a details displaying module, configured for invoking an application corresponding to the first target information to display details of the first target information.

In a specific implementation of the present application, the details displaying module includes:

an application determining sub-module, configured for determining whether the application corresponding to the first target information belongs to a preset unlock invoking list, wherein the preset unlock invoking list is used to record applications that can only be invoked after unlocking screen;

a first details displaying sub-module, configured for if the determination result from the application determining sub-module is yes, invoking the application corresponding to the first target information and displaying the details of the first target information in the invoked application, when the screen has been successfully unlocked; and

a second details displaying sub-module, configured for, if the determination result from the application determining sub-module is not, invoking directly the application corresponding to the first target information and displaying the details of the first target information in the invoked application.

In a specific implementation of the present application, the information display apparatus further includes:

a condition setting instruction receiving module, configured for receiving an instruction for setting information filtering conditions;

an interface displaying module, configured for presenting an interface for setting information filtering conditions; and

a filtering condition generating module, configured for generating an information filtering condition, according to operations by the user on the interface for setting information filtering conditions.

In a specific implementation of the present application, the interface information displaying module includes:

an information determining sub-module, configured for determining whether pieces of information in the obtained to-be-displayed information conform to the information filtering condition one by one, and

a first interface information displaying sub-module, configured for displaying, according to a determination result, a piece of information in the obtained to-be-displayed information which does not conforms to the information filtering condition and the screen unlocking area with the preset style in accordance with the preset interface layout mode.

In a specific implementation of the present application, the interface information displaying module includes:

a sequence number and number obtaining sub-module, configured for obtaining a sequence number of a second target information in the obtained to-be-displayed information and the number of pieces of information in the obtained to-be-displayed information, wherein the second target information is the information in the obtained to-be-displayed information which will be displayed;

a prompt information display determining sub-module, configured for determining whether to display prompt information for information switching according to the sequence number of the second target information and the number of pieces of information in the obtained to-be-displayed information; and

a second interface information displaying sub-module, configured for, if the determination result from the prompt information display determining sub-module is yes, displaying the prompt information for information switching, the second target information, and the screen unlocking area with the preset style, in accordance with the preset interface layout mode and a preset prompt information style.

In a specific implementation of the present application, the preset prompt information style is set so that:

the content in a second preset area of third target information is displayed in a first preset area in the locked screen interface, wherein the third target information is to-be-displayed information corresponding to a next sequence number to the sequence number of the second target information; or

the content in a fourth preset area of fourth target information is displayed in a third preset area in the locked screen interface, wherein the fourth target information is to-be-displayed information corresponding to a sequence number preceding the sequence number of the second target information; or

the prompt information for information switching is displayed with a preset graphics in a fifth preset area in the locked screen interface.

In a specific implementation of the present application, the information display apparatus further includes:

an information switching instruction receiving module, configured for receiving an information switching instruction, after the second interface information displaying sub-module displays the prompt information for information switching; and

the interface information displaying module is further configured for displaying the switched to-be-displayed information according to the information switching instruction.

In a specific implementation of the present application, the interface information displaying module further includes:

an information determining sub-module, configured for determining whether the to-be-displayed information being displayed contains preset information;

a shift condition determining sub-module, configured for, if the determination result from the information determining sub-module is yes, determining whether the preset information conforms to a preset information shift condition according to the switched to-be-displayed information corresponding to the information switching instruction; and

a third interface information displaying sub-module, configured for displaying the switched to-be-displayed information, and displaying the preset information at a preset position.

In an optional implementation of the present application, the to-be-displayed information obtaining module is specifically configured for obtaining the to-be-displayed information according to at least one of the following:

an application locked by the locked screen interface;

an application running in the foreground on the terminal before the screen is locked;

an application running in the terminal before the screen is locked;

categories of applications installed in the terminal;

frequency of use of the applications installed in the terminal;

user's interests and hobbies obtained by analyzing information on running of applications installed in the terminal;

categories of to-be-displayed information, which are set in advance by the user; and

information recommendation degree of each piece of information in a preset information repository.

In a specific implementation of the present application, the screen unlocking area with a preset style includes:

a digital type of screen unlocking area arranged according to a preset graphics; or

an image type of screen unlocking area arranged according to a preset graphics; or

a screen unlocking area for collecting images; or

a screen unlocking area for collecting sounds.

To achieve the objective above, an embodiment of the present application discloses an electronic device. The electronic device includes: a housing, a processor, a memory, a circuit board and a power supply circuit, wherein the circuit board is arranged inside a space enclosed by the housing, the processor and the memory are arranged on the circuit board; the power supply circuit is used to supply power for various circuits or components of the electronic device; the memory is used to store executable program code; and the processor executes a program corresponding to the executable program code by reading the executable program code stored on the memory for:

receiving an information display instruction for a locked screen interface;

obtaining to-be-displayed information according to a preset information determining rule; and

displaying the obtained to-be-displayed information and a screen unlocking area with a preset style according to a preset interface layout mode.

To achieve the objective above, an embodiment of the present application discloses an application program, which when being executed, performs the information display method described in each of the implementation described above.

To achieve the objective above, an embodiment of the present application discloses a storage medium, for storing executable codes, which are executed to perform the information display method described in each of the implementation described above.

As can be seen from the above, in the solution provided by the embodiments of the present application, after receiving an information display instruction for a locked screen interface, the client obtains to-be-displayed information according to a preset information determining rule, and then displays the obtained to-be-displayed information and a screen unlocking area with a preset style according to a preset interface layout mode. It can be seen that when displaying information using the solutions provided by the embodiments of the present application, the user can still obtain the information by the locked screen interface without successfully unlocking it, which enriches the way that the user obtains information and improves the user experience.

### BRIEF DESCRIPTION OF THE DRAWINGS

In order to more clearly describe the technical solution of the embodiments of the application and the prior art, drawings needed in the embodiments and the prior art will be briefly described below. Obviously, the drawings described below are for only some embodiments of the present application, one of ordinary skills in the art can also obtain other drawings based on these drawings without any creative efforts.

FIG. 1 is a schematic flowchart of a first information display method according to an embodiment of the present application;

FIG. 2a is a schematic view of a first locked screen interface provided by an embodiment of the present application;

FIG. 2b is a schematic view of a second locked screen interface provided by an embodiment of the present application;

FIG. 2c is a schematic view of a third locked screen interface provided by an embodiment of the present application;

FIG. 2d is a schematic view of a fourth locked screen interface provided by an embodiment of the present application;

FIG. 3 is a schematic flowchart of a second information display method according to an embodiment of the present application;

FIG. 4 is a schematic flowchart of a third information display method according to an embodiment of the present application;

FIG. 5a is a schematic view of a fifth locked screen interface provided by an embodiment of the present application;

FIG. 5b is a schematic view of a sixth locked screen interface provided by an embodiment of the present application;

FIG. 5c is a schematic view of a seventh locked screen interface provided by an embodiment of the present application;

FIG. 6 is a schematic diagram of a first information display apparatus according to an embodiment of the present application;

FIG. 7 is a schematic diagram of a second information display apparatus according to an embodiment of the present application;

FIG. 8 is a schematic diagram of a third information display apparatus according to an embodiment of the present application;

FIG. 9 is a schematic structure diagram of an electronic device according to an embodiment of the present application.

### DETAILED DESCRIPTION

The present application will be described in detail with reference to the accompanying drawings and embodiments, so that the objectives, technical solutions, and advantages of the present application can be better understood. Obviously, the embodiments described are only some of the embodiments of the present application instead of all the embodiments. All other embodiments obtained by those of ordinary skills in the art based on the embodiments herein without any creative efforts are within the scope of the present disclosure.

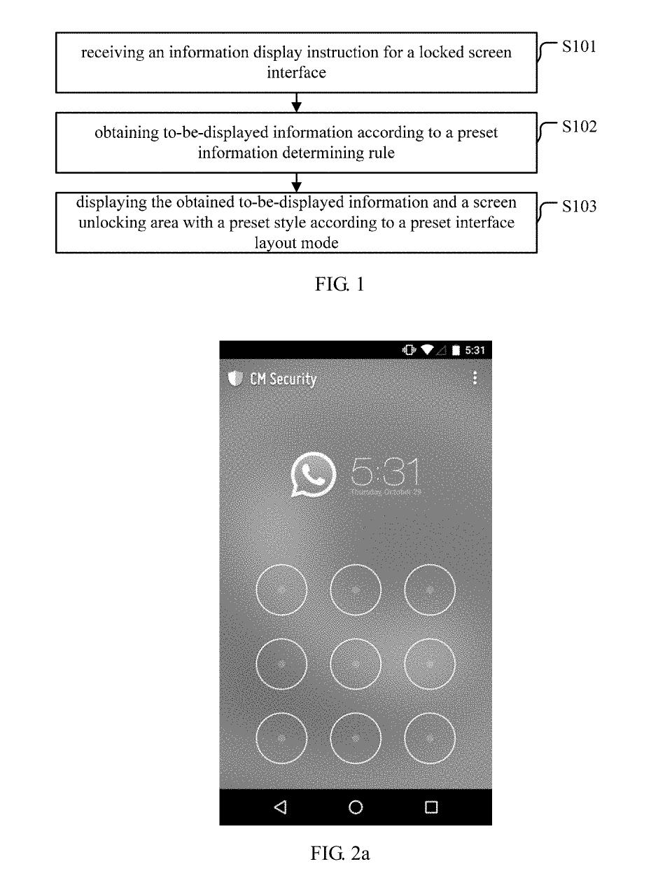

FIG. 1 is a schematic flowchart of a first information display method according to an embodiment of the present application. The method comprises:

S101: receiving an information display instruction for a locked screen interface.

Among others, the locked screen interface may be either a locked screen interface for a terminal used by a user, or a locked screen interface for an application installed in the terminal used by the user. For example, if the user does not want others to view photos stored in his mobile phone freely, the user may set a password-lock for the “Photo” application that stores and manages photos. If anyone then tries to open the application, a corresponding lock screen will be first displayed for inputting the password.

The information display instruction described above can be understood as an instruction for triggering the displaying of the locked screen interface. In practice, this information display instruction can be generated in various ways. For example, in a case where a locked screen interface has been set for the terminal, when it is detected that the user has pressed the “home” key, the power key, and the like, an information display instruction is generated; in a case where a locked screen interface has been set for a target application installed in the terminal, when it is detected that the user has clicked on the icon of the target application, an information display instruction is generated. It should be noted that the present application does not limit the way of generating information display instructions.

S102: obtaining to-be-displayed information according to a preset information determining rule.

In an optional implementation, the to-be-displayed information can be obtained according to information stored in the terminal, for example, unread text messages, missed call records stored in the terminal, unread push information from various applications which have been cached in the terminal, and the like.

In another optional implementation, the to-be-displayed information can also be obtained by sending an information obtaining request to the network. In this case, the to-be-displayed information can be successfully obtained only when the network is available.

In yet another optional implementation, the to-be-displayed information may also be obtained according to currently received information. The difference between this implementation and the foregoing optional implementations is in that no information obtaining request is sent to the network in this implementation. The currently received information can include currently received short messages, currently received push information from the applications installed in the terminal, and the like.

It should be noted that the implementations described herein are merely examples, and do not limit the way of obtaining the to-be-displayed information.

In addition, the to-be-displayed information that is obtained according to the preset information determining rule may be either one piece of information or a plurality of pieces of information. The above-mentioned to-be-displayed information can be news information, advertisement information, weather forecast information, lifehack information, and the like.

In an optional implementation of the present application, when the information to be display is obtained according to the preset information determining rule, the to-be-displayed information can be obtained according to at least one of the following:

A) An application locked by the locked screen interface. In this case, the locked screen interface can be understood as a locked screen interface for the application installed in the terminal. The above-mentioned to-be-displayed information may include: the icon of the application locked by the locked screen interface, push information from the application locked by the locked screen interface, and the like.

B) An application running in the foreground on the terminal before the screen is locked. It can be understood that the user may lock the terminal when the terminal is in the desktop state, or may lock the terminal when an application is running in the foreground. In the latter case, the probability that the user continues to access the application after unlocking the terminal is relatively high, the above-mentioned to-be-displayed information then can be information related to the application.

C) Applications running on the terminal before the screen is locked. It can be understand that generally a plurality of applications run on the terminal, which may be applications that the user frequently accesses or applications that the user has recently accessed. In this case, the above-mentioned to-be-displayed information can be push information, application upgrade information, and the like from the applications in a running state on the terminal.

D) Categories of applications installed in the terminal. It can be understood that, according to different ways of categorizing, one application can be categorized into different categories, for example, the game category, the interaction category, and the like. If the user installs applications with certain categories in his terminal, it can be considered that the user is interested in the information related to these categories. Therefore, the above-mentioned to-be-displayed information can be information related to the categories of the applications installed in the terminal.

E) Frequency of use of the applications installed in the terminal. It can be understood that the higher the frequency of use of an application installed in the terminal is, the greater the probability that the user is interested in the application will be. When determining the to-be-displayed information, the information related to the frequently used applications can be preferentially determined as the to-be-displayed information. This enables more targeted display of information, which in turn can improve the user experience.

F) User's interests and hobbies obtained by analyzing information on that the terminal runs the applications installed thereon. Specifically, information on that the terminal runs the applications installed thereon can include: the category of each of the ran applications, the accumulated run time of each of the ran applications, the maximum run duration of each of the ran applications, the frequency of running each of the applications, or the like. If the ran applications are listed in descending order of accumulated running time as follows: Taobao client, Jingdong client, Vipshop client, WeChat, and the like, it can be determined that the user likes shopping. In this case, the to-be-displayed information described above can be information related to shopping.

G) Categories of to-be-displayed information, which are set in advance by the user.

H) Information recommendation degree for each piece of information in a preset information repository, wherein the above-mentioned information recommendation degree can be understood as the user's preference for each piece of information in the preset information repository, the requirement of merchants for the frequency of pushing each piece of information in the preset information repository, the price of pushing each piece of information in the preset information repository, and the like.

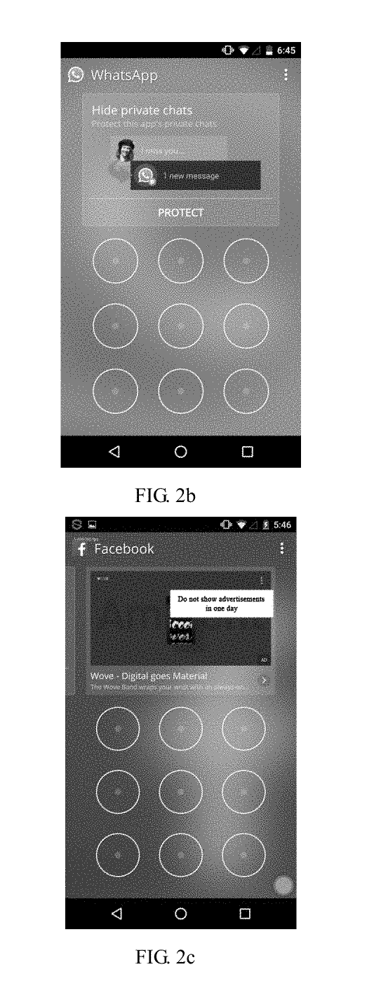

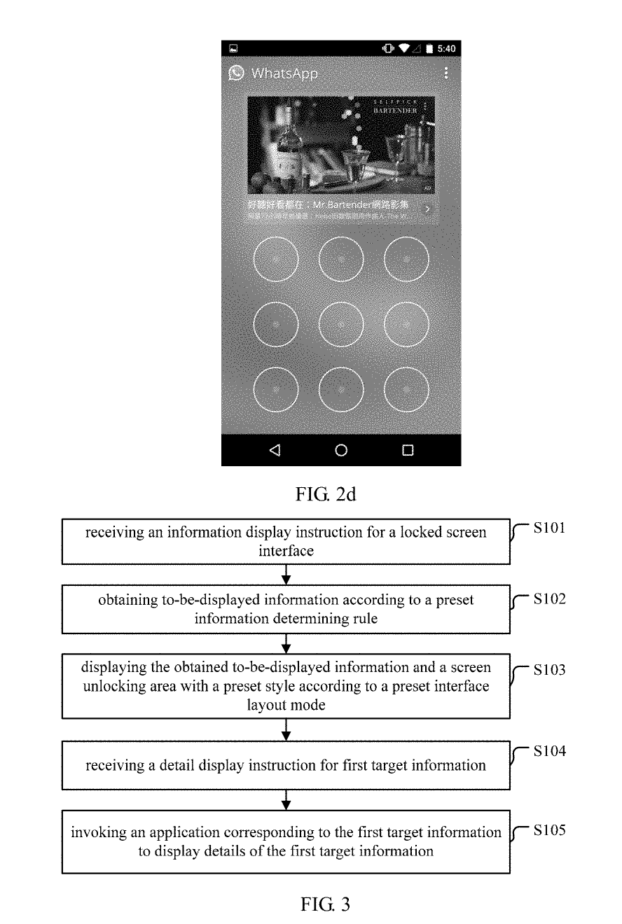

Specifically, referring to FIG. 2a and FIG. 2b, schematic diagrams of two locked screen interfaces are provided.

In FIG. 2a, the to-be-displayed information includes: the phone-pattern icon of the application locked by the locked screen interface, the current date and the specific time.

In FIG. 2b, the to-be-displayed information includes: the phone-pattern icon, identifier, and unread information prompt of the application locked by the locked interface, wherein the unread prompt information includes: the phone-pattern icon, the number of unread messages, and a part of the content of the unread messages of the application locked by the locked screen interface. In addition, the “PROTECT” menu information can further be seen in the figure. The user can perform setting operations related to the information display mode by clicking this menu item. For example, the user can set the information display mode to: a mode in which only the number of unread information, rather than any content of the unread information, is displayed, so as to enhance protection of user privacy.

S103: displaying the obtained to-be-displayed information and a screen unlocking area with a preset style according to a preset interface layout mode.

In practice, the user can set a variety of interface layout modes, or can also determine the interface layout mode according to the interface layout templates provided by developers.

For example, the interface layout mode can be set to display the to-be-displayed information in the upper half of the interface, and display the screen unlocking area in the lower half of the interface, wherein a frame with translucent and stereoscopic effects can be provided around the to-be-displayed information, and a shadow effect can even be provided at the periphery of the frame.

It should be noted that the present application is merely described by way of example, and in actual applications, the interface layout modes are not limited to the examples.

The screen unlocking area with the preset style can be a digital type of screen unlocking area arranged according to a preset graphics, an image type of screen unlocking area arranged according to a preset graphics, a screen unlocking area for collecting images, and a screen unlocking area for collecting sounds, and the like. The styles of the screen unlocking area are not limited herein.

In a preferred implementation of the present application, the information display method described above can further include:

receiving an instruction for setting information filtering conditions;

presenting an interface for setting information filtering conditions; and

generating an information filtering condition according to operations by the user on the interface for setting information filtering conditions.

Specifically, since different users have different interests and hobbies due to individuation, in practice, the information filtering condition can be set by the user. The instruction for setting information filtering conditions described above can be generated by detecting whether the user clicks a preset position or a preset icon in the interface. After receiving the instruction for setting information filtering conditions, the interface for setting information filtering condition is displayed to the user. The interface for setting information filtering conditions can include types of the information to be filtered, and the like, and can also include an area for the user to input the feature information of the information to be filtered, and the like. The user can perform information selection operations, information input operations, and the like in the interface for setting information filtering conditions. An information filtering condition is then generated according to the user's operation information.

The above-mentioned information to be filtered can be advertisement information, weather information, news information, lifehack information, and the like, which is not limited herein.

Specifically, the interface for setting information filtering conditions can present setting options for selecting by the user, such as “Do not show advertisement information in one day”, “Do not show WeChat push messages in one week”, or the like.

In view of the above situation, in an optional implementation of the present application, displaying the obtained to-be-displayed information and the screen unlocking area with the preset style according to a preset interface layout mode includes: determining whether the obtained to-be-displayed information conforms to the information filtering condition one by one, and displaying, based on a determination result, the obtained to-be-displayed information that does not conform to the information filtering condition and the screen unlocking area with the preset style according to the preset interface layout mode.

Specifically, referring to FIG. 2c, a schematic diagram of a third unlocking interface is provided. After the user clicks the “dots” icon at the upper right corner of the frame area displaying the to-be-displayed information in the interface, a setting option of “Do not show advertisement information in the day” is displayed to the user. After the user clicks the setting option, an information filtering condition is generated and the advertisement information is no longer displayed in one day.

As can be seen from the above, in the solution provided by the present embodiments, after receiving an information display instruction for a locked screen interface, the client obtains to-be-displayed information according to a preset information determining rule, and then displays the obtained to-be-displayed information and a screen unlocking area with a preset style according to a preset interface layout mode. It can be seen that, when displaying information by applying the solutions provided by the present embodiments, the user can still obtain the information by the locked screen interface without successfully unlocking it, which enriches the way for the user to obtain information and improves the user experience.

Those skilled in the art can understand that, due to the limited size of the area for displaying the to-be-displayed information in the unlocking interface, the displayed to-be-displayed information may be generally only the title of the information or a part of the information. In view of this, in a specific implementation of the present application, referring to FIG. 3, a schematic flowchart of a second information display method is provided. Compared with the foregoing embodiments, in this embodiment, the information display method described above further includes:

S104: receiving a detail display instruction for first target information.

Among others, the first target information is the information being displayed in the obtained to-be-displayed information.

Specifically, the detail display instruction can be generated when the terminal detects that the user clicks a preset type of button, for example, an “arrow-like” button, or the like; or can be generated when the terminal detects that the user clicks on a preset area, for example, the display area of the to-be-displayed information, or the like; or can be generated when the terminal detects that the trajectory swiped by the user on the display screen is a preset pattern, for example, a pattern formed by two fingers swiping outwards, or the like.

Specifically, referring to FIG. 2d, a schematic diagram of a fourth unlocking interface is provided. The first target information displayed on the interface is advertisement information, and an icon “>” is displayed on the lower right corner of the area where the advertisement is displayed. After detecting that the user clicked the icon, the terminal generates a detail display instruction. Of course, the icon “>” described above can also be displayed in other areas. What described herein are merely examples, and do not limit the present application.

S105: invoking an application corresponding to the first target information to display details of the first target information.

Particularly, since some applications do not involve privacy information of the user, in order to facilitate the user to view details of the application, it is unnecessary that the application corresponding to the information can be invoked only after the user inputs the password and the unlocking is successful performed. Instead, the application corresponding to this information is invoked directly and the details are displayed in the invoked application.

In a preferred implementation of the present application, invoking an application corresponding to the first target information to display the details of the first target information, includes: determining at first whether the application corresponding to the first target information belongs to a preset unlock invoking list; if the first target information belongs to the preset unlock invoking list, invoking the application corresponding to the first target information and displaying in the application the details of the first target information, when the screen has been successfully unlocked; if the first target information does not belong to the preset unlock invoking list, invoking directly the application corresponding to the first target information and displaying in the application the details of the first target information.

Where, the preset unlock invoking list is used to record applications that can only be invoked after unlocking screen.

It can be seen from the above, in the solution provided in the present embodiment of the present application, not only can the information of the user be enriched by means of displaying information on the locked screen interface, but also the application corresponding to the information can be further invoked to display the information details. Therefore, the way that the user obtains information can be further enriched, improving the user experience.

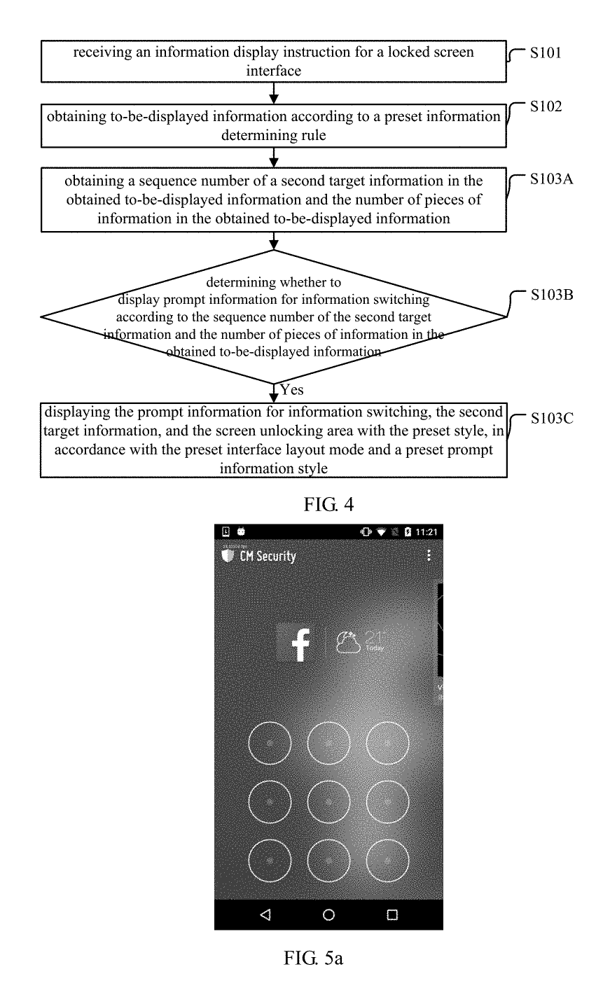

In another specific implementation of the present application, referring to FIG. 4, a flowchart of a third information display method is provided. Compared with the foregoing embodiment, in this embodiment, the S103 of displaying, according to the preset interface layout mode, the screen unlock area in the preset style and the information in the obtained to-be-displayed information which meets the preset information display rule, includes:

S103A: obtaining a sequence number of a second target information in the obtained to-be-displayed information and the number of pieces of information in the obtained to-be-displayed information.

Where, the second target information is the information in the obtained to-be-displayed information which will be displayed.

When the obtained to-be-displayed information includes a plurality of pieces of information, the pieces of information need to be displayed in a certain order. Specifically, the information can be arranged according to information recommendation degrees, information popularity, information categories, and the like, which is not limited herein.

S103B: determining whether to display prompt information for information switching according to the sequence number of the second target information and the number of pieces of information in the obtained to-be-displayed information; and performing step S103C if the prompt information for information switching needs to be displayed.

When the to-be-displayed information includes a plurality of pieces of information, displaying prompt information for information switching can help the user quickly understand the arrangement of the information.

Specifically, it can be determined whether there is to-be-displayed information before and after the second target information, according to the sequence number of the second target information and the number of the obtained to-be-displayed information described above. It is then determined whether to display the prompt information for information switching and the information switching direction to be prompted by the prompt information for information switching, according to the determination result. Where, the switching direction described above can be understood as: the direction of the sequence number preceding to or following the sequence number of the second target information, using the sequence number of the second target information as a reference.

For example, if the sequence number of the second target information is 0 (the sequence number starts from 0) and the number of to-be-displayed information is 5, it can be determined that, according to the arrangement order, there is no to-be-displayed information before the second target information, but there is to-be-displayed information after the second target information. In such case, the prompt information for information switching needs to be displayed, and the switching direction points to the to-be-displayed information whose sequence number is after the sequence number of the second target information.

If the sequence number of the second target information is 4 (the sequence number starts from 0) and the number of to-be-displayed information is 5, it can be determined that, according to the arrangement order, there is to-be-displayed information before the second target information, and there is also to-be-displayed information after the second target information. In such case, the prompt information for information switching needs to be displayed, and the switching directions respectively indicate the to-be-displayed information whose sequence number is after the sequence number of the second target information and the to-be-displayed information whose sequence number is before the sequence number of the second target information.

If the sequence number of the second target information is 2 (the sequence number starts from 0) and the number of to-be-displayed information is 5, it can be determined that, according to the arrangement order, there is to-be-displayed information before the second target information, but there is no to-be-displayed information after the second target information. In such case, the prompt information for information switching needs to be displayed, and the switching direction points to the to-be-displayed information whose sequence number is before the sequence number of the second target information.

S103C: displaying the prompt information for information switching, the second target information, and the screen unlocking area with the preset style, in accordance with the preset interface layout mode and a preset prompt information style.

Specifically, the preset prompt information style can be set so that the content in a second preset area of third target information is displayed in a first preset area in the locked screen interface, wherein the third target information is to-be-displayed information corresponding to a next sequence number to the sequence number of the second target information.

The preset prompt information style can be set so that the content in a fourth preset area of fourth target information is displayed in a third preset area in the locked screen interface, wherein the fourth target information is to-be-displayed information corresponding to a sequence number preceding the sequence number of the second target information.

The preset prompt information style can also be set so that the prompt information for information switching is displayed with a preset graphics in a fifth preset area in the locked screen interface, wherein the preset graphics can be a left arrow, a right arrow, an up arrow, a down arrow, or the like; and the fifth preset area can be an area near the middle position and outside the area for displaying the to-be-displayed information, or the like. The specific representations of the preset graphics and the fifth area are not limited herein.

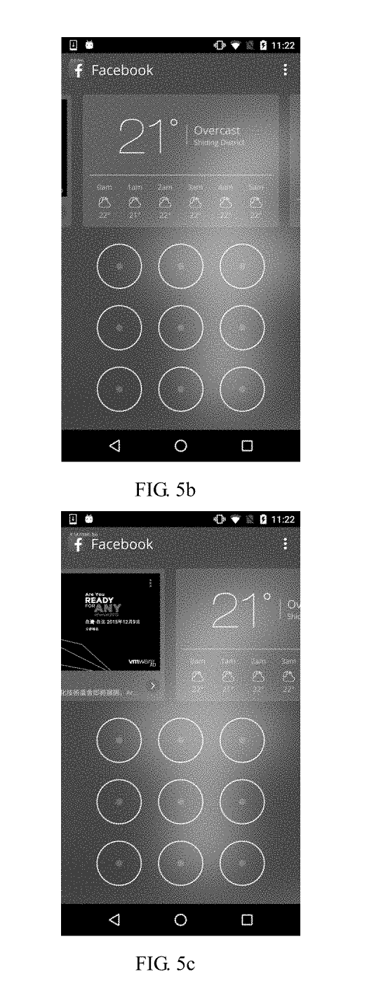

Specifically, referring to FIG. 5a and FIG. 5b, schematic diagrams of two locked screen interfaces are provided. These two lock screens display the prompt information for information switching in different styles.

In FIG. 5a, the second target information includes information such as the icon of the application, the current date, the current time, and the like. A part of the to-be-displayed information is used as the prompt information for information switching, and is displayed on the right side of the second target information. This can prompt the user that there is next to-be-displayed information after the second target information. In this figure, the area on the right side of the second target information close to the interface edge is the first preset area, and the content displayed therein corresponds to the second preset area of the third target information, i.e., the next to-be-displayed information.

In FIG. 5b, the second target information includes information such as the icon of the application, the current date, temperature, weather, and the like. A part of the to-be-displayed information is used as the prompt information for information switching, and is displayed respectively on the left side and the right side of the second target information. This can prompt the user that there is previous to-be-displayed information before the second target information, and there is next to-be-displayed information after the second target information. In this figure, the area on the right side of the second target information close to the interface edge is the first preset area, and the content displayed therein corresponds to the second preset area of the third target information, i.e., the next to-be-displayed information; the area on the left side of the second target information close to the interface edge is the third preset area, and the content displayed therein corresponds to the fourth preset area of the fourth target information, i.e., the previous to-be-displayed information.

It should be understood that what described herein are merely examples, and do not limit the present application.

In a specific implementation of the present application, the information display method described above can further include:

receiving an information switching instruction, after displaying the prompt information for information switching, the second target information, and the screen unlocking area with the preset style, in accordance with the preset interface layout mode and a preset prompt information style; and displaying the switched to-be-displayed information according to the information switching instruction.

Specifically, the information switching instruction can be sent by the user by clicking the information displayed on the interface to switch the prompt information, for example, by clicking the right arrow, the left arrow, the second preset area, the fourth preset area on the interface, or the like; the information switching instruction can also be sent by the user by swiping the interface according to the prompt information for information switching displayed on the interface, for example, by swiping the interface to the right, swiping the interface to the left, or the like; which is not limited herein.

In an optional implementation of the present application, displaying the switched to-be-displayed information according to the information switching instruction can include: determining whether the to-be-displayed information being displayed contains preset information; if the preset information is contained in the to-be-displayed information being displayed, determining whether the preset information conforms to a preset information shift condition according to the switched to-be-displayed information corresponding to the information switching instruction; and if the preset information conforms to the preset information shift condition, displaying the switched to-be-displayed information, and displaying the preset information at a preset position.

Specifically, the preset information can be information such as an application icon, an application identifier, and the like.

The preset position may be the upper left corner on the interface, the upper right corner of the interface, or the like.

The preset information shift condition can be determining whether the to-be-displayed information that has been switched to is advertisement information, news information, or the like. If so, it can be determined that the preset information meets the information shift condition.

Specifically, referring to FIG. 5c, a schematic diagram of a seventh locked screen interface is provided. The schematic diagram is a schematic diagram corresponding to the process of switching from one piece of to-be-displayed information to another piece of to-be-displayed information.

It can be seen from above, in the solution provided by the embodiment of the present application, the prompt information for information switching is displayed to the user, which enables the user to quickly understand whether there is to-be-displayed information before and after the currently displayed information, thereby further improving the user experience.

Corresponding to the foregoing information display method, an embodiment of the present application further provides an information display apparatus.

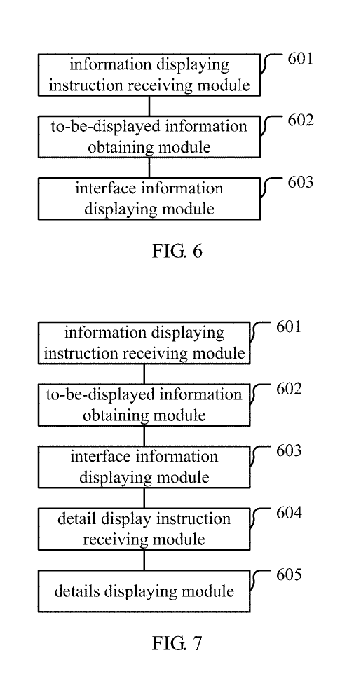

FIG. 6 is a schematic diagram of a first information display apparatus according to an embodiment of the present application. The apparatus includes:

an information displaying instruction receiving module 601, configured for receiving an information display instruction for a locked screen interface;

a to-be-displayed information obtaining module 602, configured for obtaining to-be-displayed information according to a preset information determining rule;

an interface information displaying module 603, configured for displaying the obtained to-be-displayed information and a screen unlocking area with a preset style according to a preset interface layout mode.

Specifically, the information display apparatus can further include:

a condition setting instruction receiving module, configured for receiving an instruction for setting information filtering conditions;

an interface displaying module, configured for presenting an interface for setting information filtering conditions;

a filtering condition generating module, configured for generating an information filtering condition, according to operations by the user on the interface for setting information filtering conditions.

Specifically, the interface information displaying module 603 can include:

an information determining sub-module, configured for determining whether pieces of information in the obtained to-be-displayed information conform to the information filtering condition one by one, and

a first interface information display sub-module, configured for displaying, according to a determination result, a piece of information in the obtained to-be-displayed information which does not conforms to the information filtering condition and the screen unlocking area with the preset style in accordance with the preset interface layout mode.

Specifically, the to-be-displayed information obtaining module is specifically configured for obtaining the to-be-displayed information according to at least one of the following:

an application locked by the locked screen interface;

an application running in the foreground on the terminal before the screen is locked;

an application running in the terminal before the screen is locked;

categories of applications installed in the terminal;

frequency of use of the applications installed in the terminal;

user's interests and hobbies obtained by analyzing information on running of applications installed in the terminal;

categories of to-be-displayed information, which are set in advance by the user; and

information recommendation degree of each piece of information in a preset information repository.

Specifically, the screen unlocking area with a preset style can include:

a digital type of screen unlocking area arranged according to a preset graphics; or

an image type of screen unlocking area arranged according to a preset graphics; or

a screen unlocking area for collecting images; or

a screen unlocking area for collecting sounds.

As can be seen from the above, in the solution provided by this embodiment, after receiving an information display instruction for a locked screen interface, the client obtains to-be-displayed information according to a preset information determining rule, and then displays the obtained to-be-displayed information and a screen unlocking area with a preset style according to a preset interface layout mode. It can be seen that when displaying information using the solutions provided by this embodiment, the user can still obtain the information by the locked screen interface without successfully unlocking it, which enriches the way that the user obtains information and improves the user experience.

In a specific implementation of the present application, referring to FIG. 7, a schematic diagram of the structure of a second information display device is provided. Compared with the foregoing embodiments, in this embodiment, the information display apparatus further includes:

a detail display instruction receiving module 604, configured for receiving a detail display instruction for first target information, wherein the first target information is the information being displayed in the obtained to-be-displayed information;

a details displaying module 605, configured for invoking an application corresponding to the first target information to display details of the first target information.

Specifically, the details displaying module 605 can include:

an application determining sub-module, configured for determining whether the application corresponding to the first target information belongs to a preset unlock invoking list, wherein the preset unlock invoking list is used to record applications that can only be invoked after unlocking screen;

a first details displaying sub-module, configured for, if the determination result from the application determining sub-module is yes, invoking the application corresponding to the first target information and displaying the details of the first target information in the invoked application, when the screen has been successfully unlocked;

a second details displaying sub-module, configured for, if the determination result from the application determining sub-module is not, invoking directly the application corresponding to the first target information and displaying the details of the first target information in the invoked application.

It can be seen from the above, in the solution provided in the embodiment of the present application, not only can the information of the user be enriched by means of displaying information on the locked screen interface, but also the application corresponding to the information can be further invoked to display the information details. Therefore, the way that the user obtains information can be further enriched, improving the user experience.

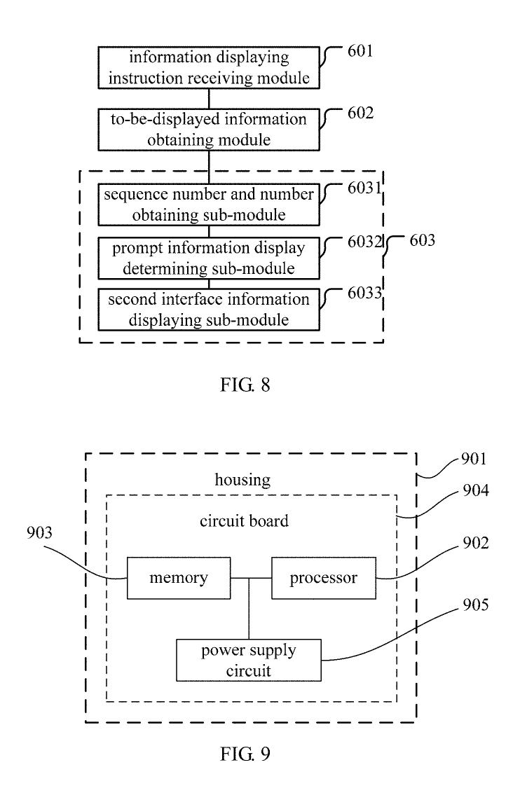

In another specific implementation of the present application, referring to FIG. 8, a schematic diagram of the structure of a third information display device is provided. Compared with the foregoing embodiments, in this embodiment, the interface information displaying module 603 includes:

a sequence number and number obtaining sub-module 6031, configured for obtaining a sequence number of a second target information in the obtained to-be-displayed information and the number of pieces of information in the obtained to-be-displayed information, wherein the second target information is the information in the obtained to-be-displayed information which will be displayed;

a prompt information display determining sub-module 6032, configured for determining whether to display prompt information for information switching according to the sequence number of the second target information and the number of pieces of information in the obtained to-be-displayed information;

a second interface information displaying sub-module 6033, configured for, if the determination result from the prompt information display determining sub-module is yes, displaying the prompt information for information switching, the second target information, and the screen unlocking area with the preset style, in accordance with the preset interface layout mode and a preset prompt information style.

Specifically, the preset prompt information style can be set so that:

the content in a second preset area of third target information is displayed in a first preset area in the locked screen interface, wherein the third target information is to-be-displayed information corresponding to a next sequence number to the sequence number of the second target information; or

the content in a fourth preset area of fourth target information is displayed in a third preset area in the locked screen interface, wherein the fourth target information is to-be-displayed information corresponding to a sequence number preceding the sequence number of the second target information; or

the prompt information for information switching is displayed with a preset graphics in a fifth preset area in the locked screen interface.

Specifically, the information display apparatus can further include:

an information switching instruction receiving module, configured for receiving an information switching instruction, after the second interface information displaying sub-module displays the prompt information for information switching;

the interface information displaying module is further configured for displaying the switched to-be-displayed information according to the information switching instruction.

Specifically, the interface information displaying module 603 can further include:

an information determining sub-module, configured for determining whether the to-be-displayed information being displayed contains preset information;

a shift condition determining sub-module, configured for, if the determination result from the information determining sub-module is yes, determining whether the preset information conforms to a preset information shift condition according to the switched to-be-displayed information corresponding to the information switching instruction; and

a third interface information displaying sub-module, configured for displaying the switched to-be-displayed information, and displaying the preset information at a preset position.

It can be seen from above, in the solution provided by the embodiment of the present application, the prompt information for information switching is displayed to the user, which enables the user to quickly understand whether there is to-be-displayed information before and after the currently displayed information, thereby further improving the user experience.

Corresponding to the foregoing information display method, an embodiment of the present application further provides an electronic device.

FIG. 9 is a schematic structure diagram of an electronic device according to an embodiment of the present application. The electronic device includes: a housing 901, a processor 902, a memory 903, a circuit board 904 and a power supply circuit 905, wherein the circuit board 904 is arranged inside a space enclosed by the housing 901, the processor 902 and the memory 903 are arranged on the circuit board 904; the power supply circuit 905 is used to supply power for various circuits or means of the electronic device; the memory 903 is used to store executable program code; and the processor 902 executes a program corresponding to the executable program code by reading the executable program code stored on the memory 903 for:

receiving an information display instruction for a locked screen interface;

obtaining to-be-displayed information according to a preset information determining rule; and

displaying the obtained to-be-displayed information and a screen unlocking area with a preset style according to a preset interface layout mode.

For a specific execution process of the foregoing steps by the processor 902 and the steps performed by the processor 902 by executing the executable program code, reference may be made to the description of the embodiments shown in FIGS. 1-8 of the present application, and details are not described herein again.

This electronic device may be embodied in a variety of forms, which includes but is not limited to:

(1) a mobile communication device: such a device is characterized in ability of mobile communication and mainly aims to provide voice and data communication. Such terminals include smart phones (such as iPhones), multimedia phones, functional phones, low-end mobile phones, and the like.

(2) an ultra-mobile personal computer device: such a device belongs to the category of personal computers, which has functions for computing and processing and generally has mobile networking features. Such terminals include PDA, MID and UMPC devices, and the like, such as iPads.

(3) a portable entertainment device: such a device can display and play multimedia content. Such devices include audio and video players (such as iPods), handhold game consoles, e-books, and smart toys and portable vehicle navigation devices.

(4) a server: a device providing computing services. The server is consisted of such as a processor, a hard disk, a memory, a system bus. The server is similar to a general computer in architecture, but has a higher requirement in aspects such as processing ability, stability, reliability, security, scalability, manageability due to the need to provide high reliable services.

(5) other electronic devices with data interaction functions.

As can be seen from the above, in the solution provided by this embodiment, after receiving an information display instruction for a locked screen interface, the electronic device obtains to-be-displayed information according to a preset information determining rule, and then displays the obtained to-be-displayed information and a screen unlocking area with a preset style according to a preset interface layout mode. It can be seen that when displaying information using the solutions provided by this embodiment, the user can still obtain the information by the locked screen interface without successfully unlocking it, which enriches the way that the user obtains information and improves the user experience.

An embodiment of the present application further provides an application program for performing the information display method provided by the embodiments of the present application when executed.

Where, the information display method includes:

receiving an information display instruction for a locked screen interface;

obtaining to-be-displayed information according to a preset information determining rule; and

displaying the obtained to-be-displayed information and a screen unlocking area with a preset style according to a preset interface layout mode.

As can be seen from the above, in the solution provided by this embodiment, the application program is executed to, after receiving an information display instruction for a locked screen interface, obtain to-be-displayed information according to a preset information determining rule, and then display the obtained to-be-displayed information and a screen unlocking area with a preset style according to a preset interface layout mode. It can be seen that when displaying information using the solutions provided by this embodiment, the user can still obtain the information by the locked screen interface without successfully unlocking it, which enriches the way that the user obtains information and improves the user experience.

An embodiment of the application further provides a storage medium for storing executable code, which is executed to perform the information display methods provided by the embodiments of the present application.

Where, the information display method includes:

receiving an information display instruction for a locked screen interface;

obtaining to-be-displayed information according to a preset information determining rule; and

displaying the obtained to-be-displayed information and a screen unlocking area with a preset style according to a preset interface layout mode.

As can be seen from the above, in the solution provided by this embodiment, the executable code stored on the storage medium is executed to, after receiving an information display instruction for a locked screen interface, obtain to-be-displayed information according to a preset information determining rule, and then display the obtained to-be-displayed information and a screen unlocking area with a preset style according to a preset interface layout mode. It can be seen that when displaying information using the solutions provided by this embodiment, the user can still obtain the information by the locked screen interface without successfully unlocking it, which enriches the way that the user obtains information and improves the user experience.

For embodiments of the apparatus, electronic device, application program and storage medium, since they are similar to the embodiments of the method, the description thereof is relatively simple; the relating parts could refer to the parts of the description of embodiments of the method.

It should be noted that the relationship terms herein such as “first”, “second” and the like, if any, are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a . . . ” or “include(s) a . . . ” do not exclude that there are other identical elements in the processes, methods, articles, or devices which include these elements.

It will be understood by those of ordinary skills in the art that all or some of the steps in the methods described above may be accomplished by a program to instruct the associated hardware. Said program may be stored in a computer-readable storage medium, such as ROMs/RAMs, magnetic disks, optical disks, etc.

The embodiments described above are merely preferred embodiments of the present application, and not intended to limit the scope thereof. Any modifications, equivalents, improvements or the like within the spirit and principle of the application should be included in the scope of the present application.

1. An information display method, comprising:
receiving an information display instruction for a locked screen interface;
obtaining to-be-displayed information according to a preset information determining rule;
displaying the obtained to-be-displayed information and a screen unlocking area with a preset style according to a preset interface layout mode;
receiving a detail display instruction for first target information, wherein the first target information is the information being displayed in the obtained to-be-displayed information; and
invoking an application corresponding to the first target information to display details of the first target information,
wherein displaying the obtained to-be-displayed information and a screen unlocking area with a preset style according to a preset interface layout mode comprises:
obtaining a sequence number of a second target information in the obtained to-be-displayed information and the number of pieces of information in the obtained to-be-displayed information, wherein the second target information is the information in the obtained to-be-displayed information which will be displayed;
determining whether to display prompt information for information switching according to the sequence number of the second target information and the number of pieces of information in the obtained to-be-displayed information; and
if it is determined to display the prompt information for information switching, displaying the prompt information for information switching, the second target information, and the screen unlocking area with the preset style, in accordance with the preset interface layout mode and a preset prompt information style.

2. (canceled)

3. The method of claim 1, wherein invoking an application corresponding to the first target information to display details of the first target information comprises:
determining whether the application corresponding to the first target information belongs to a preset unlock invoking list, wherein the preset unlock invoking list is used to record applications that can only be invoked after unlocking a screen;
if so, invoking the application corresponding to the first target information and displaying the details of the first target information in the invoked application, when the screen has been successfully unlocked; and
if not, invoking directly the application corresponding to the first target information and displaying the details of the first target information in the invoked application.

4. The method of claim 1, wherein the method further comprises:
receiving an instruction for setting information filtering conditions;
presenting an interface for setting information filtering conditions; and
generating an information filtering condition according to operations by the user on the interface for setting information filtering conditions.

5. The method of claim 4, wherein displaying the obtained to-be-displayed information and a screen unlocking area with a preset style according to a preset interface layout mode comprises:
determining whether pieces of information in the obtained to-be-displayed information conform to the information filtering condition one by one; and
displaying, according to a determination result, a piece of information in the obtained to-be-displayed information which does not conforms to the information filtering condition and the screen unlocking area with the preset style in accordance with the preset interface layout mode.

6. (canceled)

7. The method of claim 1, wherein the preset prompt information style is set so that:
the content in a second preset area of third target information is displayed in a first preset area in the locked screen interface, wherein the third target information is to-be-displayed information corresponding to a next sequence number to the sequence number of the second target information; or
the content in a fourth preset area of fourth target information is displayed in a third preset area in the locked screen interface, wherein the fourth target information is to-be-displayed information corresponding to a sequence number preceding the sequence number of the second target information; or
the prompt information for information switching is displayed with a preset graphics in a fifth preset area in the locked screen interface,
or wherein,
the method further comprises:
receiving an information switching instruction, after displaying the prompt information for information switching, the second target information, and the screen unlocking area with the preset style, in accordance with the preset interface layout mode and a preset prompt information style; and
displaying the switched to-be-displayed information according to the information switching instruction.

8. (canceled)

9. The method of claim 7, wherein displaying the switched to-be-displayed information according to the information switching instruction comprises:
determining whether the to-be-displayed information being displayed contains preset information;
if the preset information is contained in the to-be-displayed information being displayed, determining whether the preset information conforms to a preset information shift condition according to the switched to-be-displayed information corresponding to the information switching instruction; and
if the preset information conforms to the preset information shift condition, displaying the switched to-be-displayed information, and displaying the preset information at a preset position.

10. The method of claim 1, wherein obtaining to-be-displayed information according to a preset information determining rule comprises:
obtaining the to-be-displayed information according to at least one of the following:
an application locked by the locked screen interface;
an application running in the foreground on the terminal before the screen is locked;
an application running in the terminal before the screen is locked;
categories of applications installed in the terminal;
frequency of use of the applications installed in the terminal;
user's interests and hobbies obtained by analyzing information on running of applications installed in the terminal;
categories of to-be-displayed information, which are set in advance by the user; and
information recommendation degree of each piece of information in a preset information repository,
or wherein,
the screen unlocking area with the preset style comprises:
a digital type of screen unlocking area arranged according to a preset graphics; or
an image type of screen unlocking area arranged according to a preset graphics; or
a screen unlocking area for collecting images; or
a screen unlocking area for collecting sounds.

11. (canceled)

12. An information display apparatus, comprising:
an information displaying instruction receiving module, configured for receiving an information display instruction for a locked screen interface;
a to-be-displayed information obtaining module, configured for obtaining to-be-displayed information according to a preset information determining rule;
an interface information displaying module, configured for displaying the obtained to-be-displayed information and a screen unlocking area with a preset style according to a preset interface layout mode;
a detail displaying instruction receiving module, configured for receiving a detail display instruction for first target information, wherein the first target information is the information being displayed in the obtained to-be-displayed information; and
a details displaying module, configured for invoking an application corresponding to the first target information to display details of the first target information,
wherein the interface information displaying module comprises:
a sequence number and number obtaining sub-module, configured for obtaining a sequence number of a second target information in the obtained to-be-displayed information and the number of pieces of information in the obtained to-be-displayed information, wherein the second target information is the information in the obtained to-be-displayed information which will be displayed;
a prompt information display determining sub-module, configured for determining whether to display prompt information for information switching according to the sequence number of the second target information and the number of pieces of information in the obtained to-be-displayed information; and
a second interface information displaying sub-module, configured for, if the determination result from the prompt information display determining sub-module is yes, displaying the prompt information for information switching, the second target information, and the screen unlocking area with the preset style, in accordance with the preset interface layout mode and a preset prompt information style.

13. (canceled)

14. The device according to claim 12, wherein the details displaying module comprises:
an application determining sub-module, configured for determining whether the application corresponding to the first target information belongs to a preset unlock invoking list, wherein the preset unlock invoking list is used to record applications that can only be invoked after unlocking screen;
a first details displaying sub-module, configured for, if the determination result from the application determining sub-module is yes, invoking the application corresponding to the first target information and displaying the details of the first target information in the invoked application, when the screen has been successfully unlocked; and
a second details displaying sub-module, configured for, if the determination result from the application determining sub-module is not, invoking directly the application corresponding to the first target information and displaying the details of the first target information in the invoked application.

15. The apparatus of claim 12, wherein the apparatus further comprises:
a condition setting instruction receiving module, configured for receiving an instruction for setting information filtering conditions;
an interface displaying module, configured for presenting an interface for setting information filtering conditions; and
a filtering condition generating module, configured for generating an information filtering condition, according to operations by the user on the interface for setting information filtering conditions.

16. The device according to claim 15, wherein the interface information displaying module comprises:
an information determining sub-module, configured for determining whether pieces of information in the obtained to-be-displayed information conform to the information filtering condition one by one, and
a first interface information displaying sub-module, configured for displaying, according to a determination result, a piece of information in the obtained to-be-displayed information which does not conforms to the information filtering condition and the screen unlocking area with the preset style in accordance with the preset interface layout mode.

17. (canceled)

18. The apparatus of claim 12, wherein the preset prompt information style is set so that:
the content in a second preset area of third target information is displayed in a first preset area in the locked screen interface, wherein the third target information is to-be-displayed information corresponding to a next sequence number to the sequence number of the second target information; or
the content in a fourth preset area of fourth target information is displayed in a third preset area in the locked screen interface, wherein the fourth target information is to-be-displayed information corresponding to a sequence number preceding the sequence number of the second target information; or
the prompt information for information switching is displayed with a preset graphics in a fifth preset area in the locked screen interface,
or wherein,
the apparatus further comprises:
an information switching instruction receiving module, configured for receiving an information switching instruction, after the second interface information displaying sub-module displays the prompt information for information switching; and
the interface information displaying module is further configured for displaying the switched to-be-displayed information according to the information switching instruction.

19. (canceled)

20. The device according to claim 18, wherein the interface information displaying module further comprises:
an information determining sub-module, configured for determining whether the to-be-displayed information being displayed contains preset information;
a shift condition determining sub-module, configured for, if the determination result from the information determining sub-module is yes, determining whether the preset information conforms to a preset information shift condition according to the switched to-be-displayed information corresponding to the information switching instruction; and
a third interface information displaying sub-module, configured for displaying the switched to-be-displayed information, and displaying the preset information at a preset position.

21. The apparatus of claim 12, wherein the to-be-displayed information obtaining module is configured for obtaining the to-be-displayed information according to at least one of the following:
an application locked by the locked screen interface;
an application running in the foreground on the terminal before the screen is locked;
an application running in the terminal before the screen is locked;
categories of applications installed in the terminal;
frequency of use of the applications installed in the terminal;
user's interests and hobbies obtained by analyzing information on running of applications installed in the terminal;
categories of to-be-displayed information, which are set in advance by the user; and
information recommendation degree of each piece of information in a preset information repository,
or wherein,
the screen unlocking area with a preset style comprises:
a digital type of screen unlocking area arranged according to a preset graphics; or
an image type of screen unlocking area arranged according to a preset graphics; or
a screen unlocking area for collecting images; or
a screen unlocking area for collecting sounds.

22. (canceled)

23. An electronic device, comprising: a housing, a processor, a memory, a circuit board and a power supply circuit, wherein the circuit board is arranged inside a space enclosed by the housing, the processor and the memory are arranged on the circuit board; the power supply circuit is used to supply power for various circuits or components of the electronic device; the memory is used to store executable program code; and the processor executes a program corresponding to the executable program code by reading the executable program code stored on the memory for:
receiving an information display instruction for a locked screen interface;
obtaining to-be-displayed information according to a preset information determining rule; and
displaying the obtained to-be-displayed information and a screen unlocking area with a preset style according to a preset interface layout mode;
receiving a detail display instruction for first target information, wherein the first target information is the information being displayed in the obtained to-be-displayed information; and
invoking an application corresponding to the first target information to display details of the first target information,
wherein displaying the obtained to-be-displayed information and a screen unlocking area with a preset style according to a preset interface layout mode comprises:
obtaining a sequence number of a second target information in the obtained to-be-displayed information and the number of pieces of information in the obtained to-be-displayed information, wherein the second target information is the information in the obtained to-be-displayed information which will be displayed;
determining whether to display prompt information for information switching according to the sequence number of the second target information and the number of pieces of information in the obtained to-be-displayed information; and
if it is determined to display the prompt information for information switching, displaying the prompt information for information switching, the second target information, and the screen unlocking area with the preset style, in accordance with the preset interface layout mode and a preset prompt information style.

24. (canceled)

25. A non-transitory storage medium, which is configured for storing executable program code, wherein the executable program codes is used for carrying out the information display method of claim 1.
